(19) United States
(12) Patent Application Publication
(10) Pub. No.: US 2011/0092208 A1
(43) Pub. Date: Apr. 21, 2011

(54) METHOD AND APPARATUS FOR UNIFYING DIFFERENT MULTI-MODE SYSTEM SELECTION FRAMEWORKS

(75) Inventors: Arvind Swaminathan, San Diego, CA (US); Srinivasan Balasubramanian, San Diego, CA (US); Shyamal Ramachandran, San Diego, CA (US); Thomas Klingenbrunn, San Diego, CA (US)

(73) Assignee: QUALCOMM Incorporated, San Diego, CA (US)

(21) Appl. No.: 12/756,812

(22) Filed: Apr. 8, 2010

Related U.S. Application Data
(60) Provisional application No. 61/168,525, filed on Apr. 10, 2009.

(51) Int. Cl. H04W 48/18

(52) U.S. Cl. 455/435.3; 455/435.2

(57) ABSTRACT

A unified approach multi-mode system selection is provided for a mobile device implementing multiple multi-mode system selection (MMSS). Different system operators may provide their own MMSS databases and rules in different frameworks. To allow a mobile device to perform MMSS without modifying its software, the different databases may be mapped into a common database. In one example, an MMSS solution is implemented that uses a Preferred Roaming List (PRL) database according to a 3GPP2 system selection to specify the prioritization of 3GPP and 3GPP2 systems the mobile device. When the mobile device is powered up, the information in the different MMSS databases is mapped into a common database (“PRL with PLMN records”). The wireless communication device then acts on this information in the common database to perform system selection.

### CLAIM OF PRIORITY UNDER 35 U.S.C. §119

The present application for patent claims priority to Provisional Application No. 61/168,525 entitled “A Method and Apparatus for Implementing Multi-Mode System Selection Algorithms” filed Apr. 10, 2009, the entire disclosure of which is hereby expressly incorporated by reference herein.

### FIELD

At least one feature relates to network selection by multi-mode communication devices, and in particular to a unified approach for selection of network information from information for a plurality of different networks implementing different communication standards.

### BACKGROUND

Wireless communication networks are widely deployed to provide various types of communication content such as voice, data, and so on. These networks may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems. Additionally, these networks may implement different communication standards, e.g., standards specified by the 3rd Generation Partnership Project (3GPP) based on evolved Global System for Mobile Communications (GSM) or standards specified by the 3rd Generation Partnership Project 2 (3GPP2) based on CDMA2000 (e.g., IS-2000 and Evolution-Data Optimized (EV-DO)).

Some wireless communication devices are multi-mode, which means that they are capable of communicating over different types of networks. This allows such multi-mode communication devices to adapt its communications as it moves to different regions served by different networks. However, different network operators may implement different system selection approaches (e.g., network priorities, selection rules, etc.) for each network type. The framework for multi-mode system selection (MMSS) Multiple frameworks for addressing the MMSS problem have been defined in different standards bodies. Consequently, different operators might choose different MMSS frameworks based on the requirements of each operator. Implementing, testing and maintaining different flavors of MMSS is difficult and time consuming.

Consequently, a method is needed that facilitates network selection within wireless communication devices while supporting different types of network MMSS frameworks.

### SUMMARY

A mobile device and/or method operational in the mobile device are provided for multi-mode system selection. The mobile device may be provisioned with a first database including one or more geographic records, each geographic record for storing one or more communication system entries having a first type of data structure. The one or more communication system entries to be used for establishing communications in a region. The second database may include one or more multi-mode system selection entries having a second type of data structure different from the first type of data structure. The multi-mode system selection entries from the second database may be mapped to geographic records in the first database. Entries in each geographic record may then be arranged according to an order of priority. For example, arranging the entries in each geographic record according to an order of priority may include determining the order of priority of entries in each geographic record according to ranking rules in a third database of system priorities. Each entry in a geographic record may also be associated with an acquisition record that defines one or more communication channels associated with that entry. The mapping and/or arranging or entries from the second database into the first database may occur upon boot-up of the mobile device and may be performed any time the second database is updated by a system/network operator. In this manner, a single (unified) database is created from which the mobile device may select a system/network. By using an existing database framework (e.g., a PRL database as specified by 3GPP2) as the first database, and existing or established database framework may e leveraged to store other types of database frameworks.

In order to establish communication service, the mobile device may identify its current operating region. The mobile device may then perform multi-mode system selection using the first database by selecting a geographic record corresponding to the current operating region and selecting the first communication system based on the current operating region. Network communication service may then be established by selecting a first communication system from a geographic record corresponding to a current operating region for the mobile device. The first communication system may be identified as a system entry of highest priority within the selected geographic record. The first type of data structure may be compatible with a 3rd Generation Partnership Project 2 (3GPP2) Preferred Roaming List (PRL) data structure. The second type of data structure may be compatible with a 3rd Generation Partnership Project (3GPP) Public Land Mobile Network (PLMN) data structure.

Note that the mobile device may be provisioned with additional databases of multi-mode system selection entries, where the second database and additional databases may be provided by one or more network operators.

According to one example, mapping the multi-mode system selection (MMSS) entries from the second database to geographic records in the first database may include: (a) obtaining a first MMSS entry from the second database; (b) determining a first MMSS Location Priority List (MLPL) associated with the first MMSS entry; (c) determining a first MMSS System Priority List (MSPL) index linked to the first MLPL entry; (d) determining all existing MMSS Location Priority List (MLPL) records in the first database that are associated with the first MSPL index; and/or (e) identifying one or more geographic records in the first database having an existing MMSS Location Priority List record associated with the first MSPL index. The first MMSS entry may be added to each geographic record in the first database having an existing MLPL record associated with the first MSPL index. Alternatively, the first MMSS entry may be added to a newly created geographic record in the first database if no existing geographic records in the first database have a MLPL record associated with the first MSPL index. The first MMSS entry may be a Public Land Mobile Network (PLMN) entry. Arranging entries in each geographic record according to an order of priority may include determining the order of priority of entries in each geographic record according to ranking rules in a multi-mode system selection (MMSS) System Priority List associated with the first MSPL index.

### BRIEF DESCRIPTION OF THE DRAWINGS

FIG. 1 illustrates an example of network environment in which a wireless communication device may be adapted to perform a unified multi-mode system selection process using a common database.

FIG. 2 illustrates another example of a network environment in which a wireless communication device may be adapted to perform a unified multi-mode system selection process using a common database.

FIG. 3 illustrates a first multi-mode system selection (MMSS) approach in which the network operator defines a 3GPP-based Public Land Mobile Network (PLMN) database within a 3GPP2 Preferred Roaming List (PRL) database.

FIG. 4 illustrates a second multi-mode system selection (MMSS) approach in which the network operator defines a 3GPP2 Preferred Roaming List (PRL) database within a 3GPP-based Public Land Mobile Network (PLMN) database.

FIG. 5 illustrates a third multi-mode system selection (MMSS) approach in which the network operator defines an overlay database which serves to store both a 3GPP-based Public Land Mobile Network (PLMN) database and a 3GPP2 Preferred Roaming List (PRL) database.

FIG. 6 illustrates how a unified database may serve to store a plurality of different multi-mode system selection (MMSS) databases under a single framework, where all or some of the plurality of databases may originally have been defined under different frameworks.

FIG. 7 is a block diagram illustrating the functions, components, and/or processes for creating and/or using a unified database using a PRL-based 3GPP2 framework.

FIG. 8 illustrates an example of how various types of MMSS frameworks, provisioned within a mobile device, may be converted into 3GPP2 MMSS PRL-based framework (e.g., PLMN records in a PRL database).

FIG. 9 illustrates how to map EHPLMN entries from the PLMN database 804 into the PRL database, so that the geographic records for each PLMN database entry may be determined.

FIG. 10 illustrates how to map OPLMN entries from the PLMN database 804 into the PRL database, so that the geographic records for each PLMN database entry may be determined.

FIG. 11 illustrates the resulting unified database with updated geographic records after mapping the PLMN system entries into the PRL database but before arranging the entries according to an order of priority or preference within each geographic record.

FIG. 12 illustrates the resulting unified database with updated geographic records after the entries have been rearranged according to an order of priority within each geographic record.

FIG. 13 illustrates how the PLMN system records that have been added to the PRL database are linked to acquisition records.

FIG. 14 illustrates another example of how various types of MMSS frameworks, provisioned within a mobile device, may be converted into 3GPP2 MMSS PRL-based framework when a single MMSS priority list is used.

FIG. 15 illustrates a first special case where the PLMN database has a non-MLPL PLMN record.

FIG. 16 illustrates a second special case where the PRL has a non-MLPL CDMA2000 record.

FIG. 17 illustrates a third special case where the PRL has an entire GEO with non-MLPL CDMA2000 records.

FIG. 18 illustrates a method that may be operational in a mobile device for performing multi-mode system selection using a unified database.

FIGS. 19A and 19B illustrates a method that may be operational in a mobile device for performing multi-mode system selection (MMSS) using a PRL database that incorporates records from a PLMN database.

FIG. 20 is a block diagram illustrating an example of a mobile device that may be configured to perform multi-mode system selection where multiple different MMSS frameworks are converted to a single unified database.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail so as not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

### OVERVIEW

According to one feature, a unified approach to network/system selection is provided for a mobile device implementing multi-mode system selection (MMSS). For example, a multi-mode wireless communication device may be capable of communicating according to GSM, cdma2000, Data Optimized (DO), Wideband CDMA (WCDMA), and/or Long Term Evolution (LTE) standards from which it may select a preferred air interface. The selection of a preferred network/system may depend on a number of factors such as the operating region of the wireless communication device (also referred to as mobile station, access terminal, client terminal, mobile phone, etc.), roaming agreements between operators among others. The framework for multi-mode system selection (MMSS) includes two parts: (a) provisioning of databases in the wireless communication device with a list of systems; and (b) specifying a set of rules used by the wireless communication device to determine the most preferred system (e.g., wireless technology, network, or operator) available in its current operating region using the provisioned database.

Multiple frameworks for addressing the MMSS problem have been defined in different standards bodies. Based on their requirements, each system/network operator may choose a different MMSS framework. Implementing, testing and maintaining these different types of MMSS frameworks within a wireless communication device is difficult. Consequently, a novel method is provided in which the databases and the rules in a plurality of different MMSS frameworks are converted operate under a common database. This allows leveraging different existing MMSS framework implementations that support different operator requirements while reducing the maintenance and testing required if these different MMSS frameworks had to be redefined from scratch.

One novel aspect recognizes that the Preferred Roaming List database (PRL) used in 3GPP2 system selection has the highest level of granularity in specifying, grouping and prioritizing systems. Hence, a MMSS solution that uses the PRL (PRL-based MMSS) to specify the prioritization of 3GPP and 3GPP2 systems a mobile has the best performance in terms of capturing complex operator agreements, acquisition time and standby time. A database (e.g., a MMSS solution based on PRL) may hereinafter be referred to as “PRL with PLMN records”. In addition, the information in the databases used in the other MMSS solution can be captured without any loss of information in the PRL with PLMN records database.

According to one approach, an operator provisions a wireless communication device with the databases used in the MMSS solution selected by the operator. At first-time power up, the information in these databases is mapped into a common database (“PRL with PLMN records”) and is stored in non-volatile memory in the wireless communication device. The wireless communication device then acts on this information in the common database to perform system selection. During subsequent power-ups, the mapping function may be repeated only if any of the provisioned databases change. Because the framework of the common database (e.g., PRL-based MMSS) may be previously implemented, it is already tested for commercial release and avoids implementing and testing a new MMSS solution that may be desired by each system or network operator.

### Exemplary Network Environments

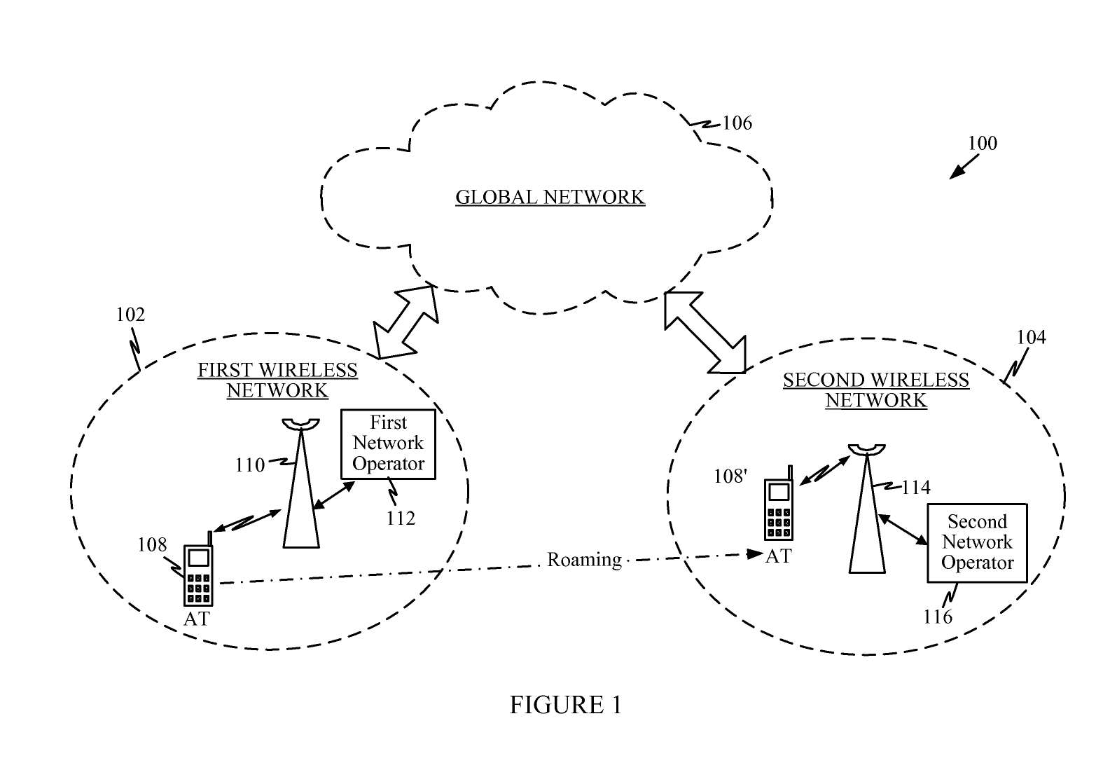

FIG. 1 illustrates an example of network environment in which a wireless communication device may be adapted to perform a unified multi-mode system selection process using a common database. The network environment 100 may include a plurality of linked networks, such as a first wireless network 102, a second wireless network 104, and a global network 106. For example, the first wireless network 102 may provide wireless connectivity to mobile devices (i.e., wireless communication devices) via one or more wireless access points 110. The first wireless network 102 may be operated by a first network operator 112 according to a first wireless communication standard. For example, the first wireless operator 112 may implement a first multi-mode system selection (MMSS) database having a first database framework. Similarly, a second wireless network 104 may provide wireless connectivity to mobile devices via one or more wireless access points 114. The second wireless network 104 may be operated by a second network operator 116 according to a second wireless communication standard. For example, the second wireless operator 116 may implement a second MMSS database having a second database framework.

The global network 106 may include a plurality of inter-connected networks, such as the Internet, may be communicatively coupled (or include) the first and second wireless networks 102 and 104. The global network 106 may be a packet switched network (such as the Internet).

The mobile device 108 may be capable of operating according to multiple communication standards (e.g., standards defined by 3GPP and 3GPP2, for example). As the mobile device 108 roams from the first wireless network 102 and into the second wireless network 104, the mobile device 108 may change network operators (from the first network operator 112 to the second network operator 116). As a result of moving into the second wireless network 104, the mobile device 108′ may also change from using the first MMSS database to the second MMSS database.

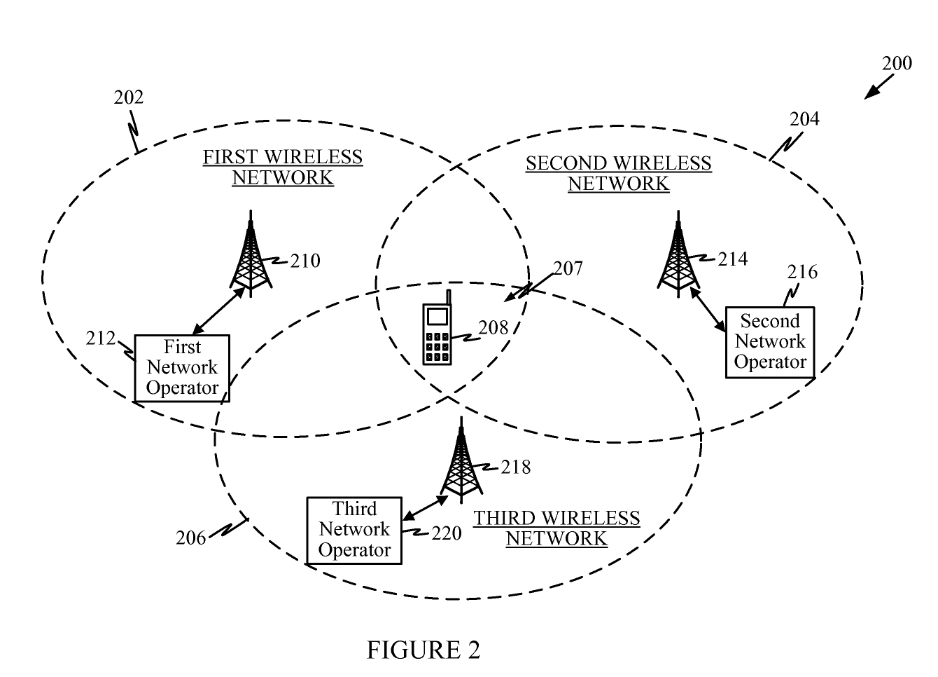

FIG. 2 illustrates another example of a network environment in which a wireless communication device may be adapted to perform a unified multi-mode system selection process using a common database. The network environment 200 may include a plurality of networks, such as a first wireless network 202, a second wireless network 104, and a third wireless network 106. In contrast to the example in FIG. 1, two or more of the networks 202, 204, and/or 206 may have overlapping network regions 207 of operation. For example, the first wireless network 202 may provide wireless connectivity to mobile devices (i.e., wireless communication devices) via one or more wireless access points 210 and may be operated by a first network operator 212 according to a first wireless communication standard (e.g., implementing a first multi-mode system selection (MMSS) database having a first database framework). Similarly, a second wireless network 204 may provide wireless connectivity to mobile devices (i.e., wireless communication devices) via one or more wireless access points 214 and may be operated by a second network operator 216 according to a second wireless communication standard (e.g., implementing a second multi-mode system selection (MMSS) database having a second database framework). Likewise, a third wireless network 206 may provide wireless connectivity to mobile devices (i.e., wireless communication devices) via one or more wireless access points 218 and may be operated by a third network operator 220 according to a third wireless communication standard (e.g., implementing a third multi-mode system selection (MMSS) database having a third database framework). Note that the first, second, and/or third database frameworks may be distinct from each other.

The mobile device 208 may be capable of operating according to multiple communication standards (e.g., standards defined by 3GPP and 3GPP2, for example). As the mobile device 208 moves into a region 207, where two or more of the networks 202, 204, and/or 206 operate, it may have to decide between establishing communications via the first, second, or third network 202, 204, or 206. In making such decision, the mobile device 208 may have to select from among the available databases (e.g., first, second, and third multi-mode system selection (MMSS) databases) and/or implement a set of rules that define a priority among the available networks 202, 204 and/or 206.

Because the different network operators may define different MMSS databases and use different database frameworks (e.g., internal database structures), a mobile device would typically have to be programmed differently depending on the database framework selected by each network operator. That is, because different database frameworks may be used by different operators, a mobile device would have to be programmed according the database framework used by the network operator with which the mobile device is to be used. This would entail significant inconvenience for a mobile device manufacturer which would have to customize the code operating in the mobile device to perform multi-mode system selection according the database framework utilized by each network operator.

To overcome this inconvenience, a unified MMSS database framework is provided in which different database frameworks which may be utilized by network operators may instead be mapped to a common (unified) database. This allows a mobile device to use the same operating code (e.g., executable instructions) across different network operators (e.g., each of which may use a different MMSS database framework) since the different MMSS database frameworks are mapped to just one database framework.

### Unified MMSS Database Structure Solution

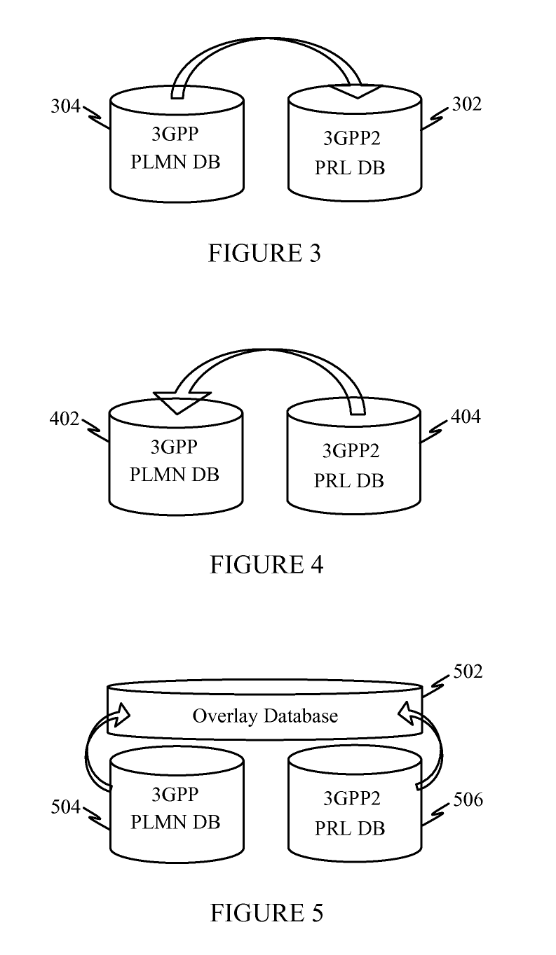

FIGS. 3, 4, and 5 illustrate three possible approaches that may be utilized by network operators for multi-mode system selection (MMSS). Each of these approaches entails using a different database framework. For purposes of illustration, the examples in FIGS. 3, 4, and 5 refer to MMSS databases for 3GPP and 3GPP2 systems or networks.

According to one example, a Preferred Roaming List (PRL) is a database residing in a wireless mobile device for over-the-air service provisioning according to a 3GPP2 compliant standard. The PRL database may contain information used during the system selection and acquisition process of the mobile device. For example, the PRL database may indicate which channels (e.g., frequency bands, sub bands, etc.) and/or service provider identifiers will be scanned and in what priority order. The PRL database is built by a network operator or service provider and may be updated by the service provide or network operator. Many operators allow the mobile device to download the latest PRL database over-the-air (OTA). The PRL database may be used to identify home networks along with roaming partners, thus making the PRL database an actual list that determines the total coverage of the subscriber, both home and roaming coverage. The PRL database may allow the mobile device to choose the best roaming carriers, particularly “roaming partners” with whom the home carrier has a cost-saving roaming agreement, rather than using non-affiliated carriers. In one implementation, the PRL database may comprise a System Table and an Acquisition Table.

The System Table may be a prioritized list of systems/networks that the mobile device is permitted to access (e.g., Preferred Systems) and those that it is explicitly forbidden to access (e.g., Negative Systems). Each System Table entry may belong to a geographic area known as a GEO. These GEOs (also referred herein as geographic records) may include one or more system/network entries listed in priority order. Each entry may also provide an acquisition table index where the frequencies associated with that system/network are identified.

The Acquisition Table may be an indexed list of channels/frequencies on which the mobile device may search for particular systems (e.g., networks) and may allow optimizing the acquisition time by identifying only the channels/frequencies that should be searched in a particular region, rather than searching the entire frequency spectrum. The information contained in each Acquisition Table entry may include an index, the network type, and associated channels/frequencies.

According to one example, a Public Land Mobile Network (PLMN) is a geographical area in which a particular operator provides mobile communication services to users. As used in 3GPP standards, a PLMN has an identifier including two fields: a first field having a Mobile Country Code (MCC) of a country to which a PLMN belongs; and a second field having a Mobile Network Code (MNC) granted to a PLMN of a given operator in order to discriminate from a PLMN of another operator in the same country. A PLMN may be described by a limited set of access interfaces and a limited set of PLMN connection types to support telecommunication services. Each operator may define its PLMN database.

Because, the PLMN database structure is different from the PRL database structure, a multi-mode system selection software in the mobile device is not able to process both databases concurrently. Therefore, mobile device may instead be configured to convert one or both databases into a unified database that can be accessed by the multi-mode system selection software.

FIG. 3 illustrates a first multi-mode system selection (MMSS) approach in which the network operator defines a 3GPP-based Public Land Mobile Network (PLMN) database 304 within a 3GPP2 Preferred Roaming List (PRL) database 302. That is, the structure or fields of the PLMN database 304 are mapped into the PRL database 302, thereby allowing both PRL and PLMN information to be stored within the 3GPP2 PRL database 302. Thus, the 3GPP2 framework is reused for system selection while 3GPP systems are specified in the PRL structure of the 3GPP2 framework.

FIG. 4 illustrates a second multi-mode system selection (MMSS) approach in which the network operator defines a 3GPP2 Preferred Roaming List (PRL) database 404 within a 3GPP-based Public Land Mobile Network (PLMN) database 402. That is, the structure or fields of the PRL database 404 are mapped into the PLMN database 402, thereby allowing both PRL and PLMN information to be stored within the 3GPP PLMN database 402. Thus, the 3GPP framework is reused for system selection while 3GPP2 systems are specified in the PLMN structure of the 3GPP framework. In one example, the PRL database 404 may store entries/records according to a CDMA2000 format.

FIG. 5 illustrates a third multi-mode system selection (MMSS) approach in which the network operator defines an overlay database 502 which serves to store both a 3GPP-based Public Land Mobile Network (PLMN) database 504 and a 3GPP2 Preferred Roaming List (PRL) database 506. That is, the overlay database 502 may be a customized data structure specifically designed to accommodate the structure or fields of both the PLMN database 504 and the PRL database 506. In this third approach, the PRL database 506 and PLMN database 504 may remain unchanged, e.g., the most preferred 3GPP system is selected using the existing 3GPP framework while the most preferred 3GPP2 system is selected using the existing 3GPP2 framework. Additionally, the overlay database 502 may also be used to specify prioritization across 3GPP and 3GPP2 systems.

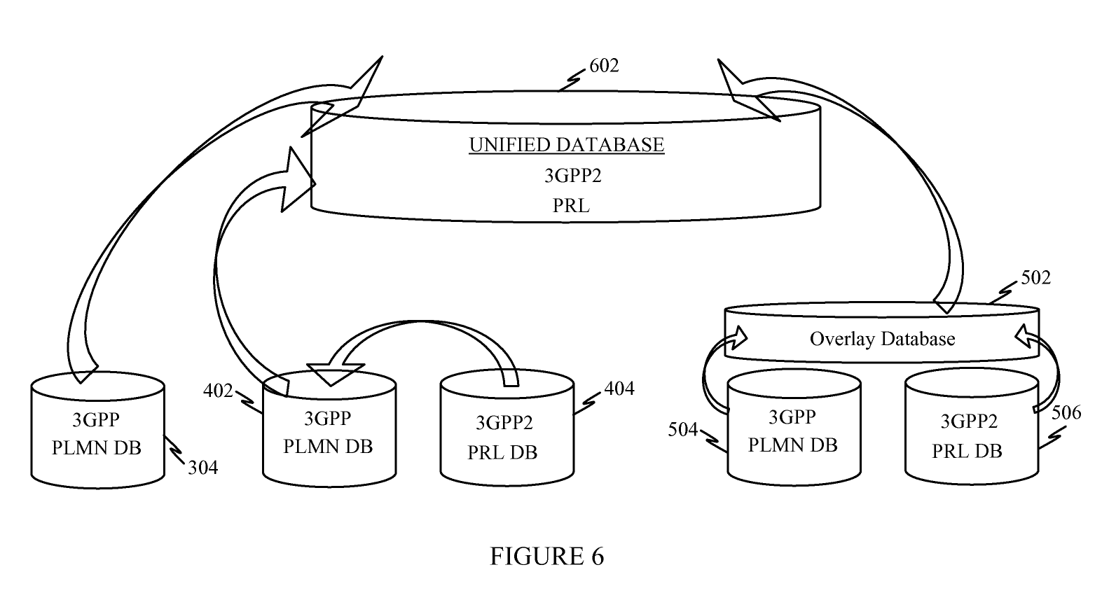

FIG. 6 illustrates how a unified database may serve to store a plurality of different multi-mode system selection (MMSS) databases under a single framework, where all or some of the plurality of databases may originally have been defined under different frameworks. In this example, the unified database 602 may be a PRL database, which may have the highest level of granularity in specifying, grouping and/or prioritizing systems. For instance, the PRL database 602 may: (a) associate each system/network (e.g., databases 304, 402 or 502) with a set of frequencies on which it is deployed; (b) group systems in the same region or area based on geographic proximity or locality concepts, and/or (c) allow geographic-specific rules to prioritize systems/networks. By utilizing the PRL database framework as the unified database framework, the information in the other databases 304, 402, and/or 502 (e.g., PLMN databases or overlay database) may be captured option without loss of information. By contrast, the information in the PRL database cannot be captured using the other databases (e.g., PLMN database) without loss of information.

According to one approach, the unified MMSS database is defined according to a PRL framework (e.g., as defined by 3GPP2). A mapping table may then be used to map information in other types of databases (e.g., PLMN databases, overlay database, etc.). For instance, a PLMN database may be converted into “PLMN records in PRL” database.

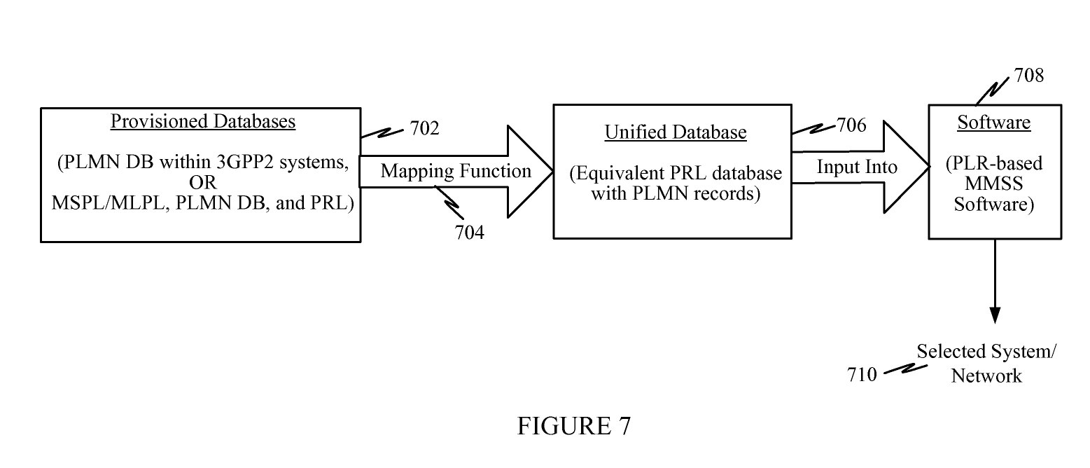

FIG. 7 is a block diagram illustrating the functions, components, and/or processes for creating and/or using a unified database using a PRL-based 3GPP2 framework. Provisioned databases 702 (e.g., PLMN database with 3GPP2 systems, MSPL/MLPL, PLMN database, and/or PRL) are mapped by a mapping function 704 into the unified database 706. The unified database 706 which may, for example, represent a provisioned PLMN database as a PRL database with PLMN records. A mobile device may use existing PRL-based MMSS software 708 to access and select 710 a system/network from the unified database 706. Consequently, the mapping function 704 allows the implementation of any MMSS algorithm or framework using a single (common) MMSS software that has already been tested and implemented for a mobile device.

In mapping to a 3GPP2 MMSS database, a PRL (e.g., also referred to as a PRL database) can be thought of as a series of GEOs (e.g., geographical profiles providing network information within a region) with 3GPP2 system/network records therein. To convert the information from PLMN databases into a 3GPP2 MMSS database framework, a determination is made as to the GEO(s) in which each entry in the PLMN database belongs. A priority of the PLMN in the GEO is then determined and the system record is inserted into the appropriate position in the GEO. The inserted PLMN system record is then linked to an acquisition record within the 3GPP2 MMSS database.

The 3GPP2 MMSS may have two overlay databases, a MMSS Location Priority List (MLPL) and a MMSS System Priority List (MSPL). The MLPL may be used to identify and/or group systems/networks. The MSPL may specify a relative priority among a group of systems/networks.

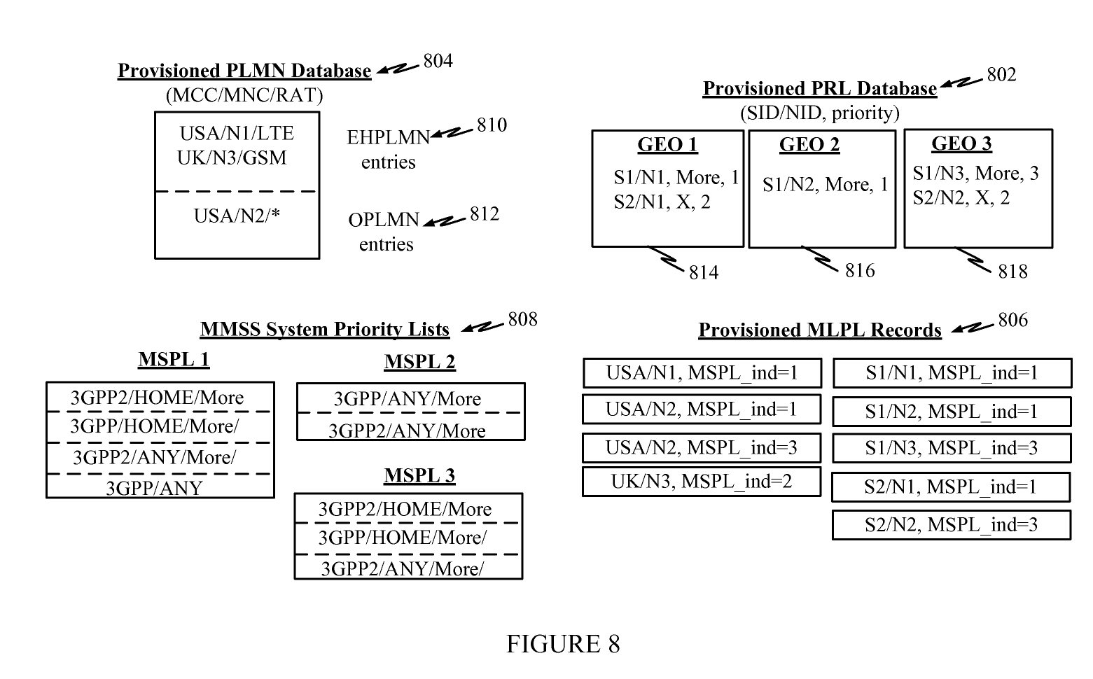

FIG. 8 illustrates an example of how various types of MMSS frameworks, provisioned within a mobile device, may be converted into a 3GPP2 MMSS PRL-based framework (e.g., a PLMN records in a PRL database). In this example, the mobile device may be provisioned with a PRL database 802, a PLMN database 804, a MMSS Location Priority List (MLPL) 806 and/or a MMSS System Priority List (MSPL) 808.

The PRL database 802 may define System Identification Numbers (SID), Network Identification Numbers (NID), and/or acquisition index which may be associated with one or more geographic regions (GEOs) 814, 816, and/or 818 (e.g., also referred to as geographic records). For example, the SID/NID pairs may identify system/network operators that may provide wireless service in particular geographic regions while the acquisition index may define the communication channel(s) and/or radio access technology for each SID/NID specified.

The PLMN database 804 may define one or more Mobile Network Codes (MNC), Mobile Country Codes (MCC), and/or Radio Access Technologies (RAT) that may be available to a mobile device. These may be arranged as Equivalent Home PLMN (EHPLMN) entries 810 and/or Operator PLMN (OPLMN) entries 812, among other types of entries.

Note that the PRL database 802 and PLMN database 804 may have different database frameworks (e.g., the way in which records are stored or arranged in each database is different). In this example, the PLMN database 804 may be arranged as a list of country/network pairs (Mobile Country Codes (MCC)/Mobile Network Code (MNC)), and Radio Access Technologies (RAT) for each country/network pair. The list may be segmented into EHPLMN and OPLMN entries. By contrast, the PRL database 802 may be arranged as distinct geographic records (GEOs) in which the systems/networks operating in a corresponding geographic region are stored. In contrast to the list used in the PLMN database, each geographic record may include only those systems/networks that may be accessed in a particular region.

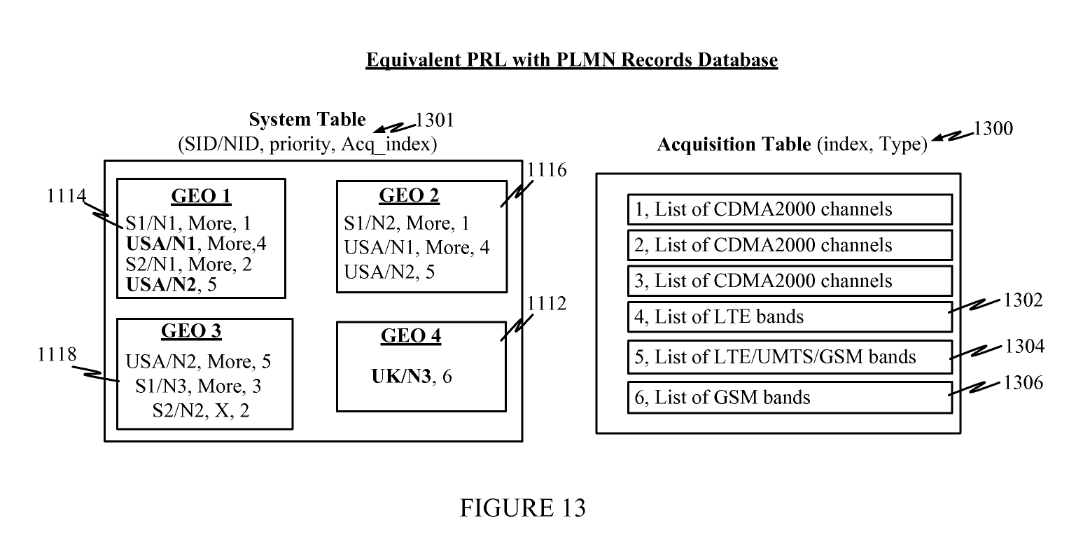

Additionally, the PRL database 802 and PLMN database 804 may store information in records having different data structures. For example, the PRL database 802 may include a System Table 1301 (FIG. 13) defining one or more geographic records (GEOs) 814, 816, and 818, each geographic record defining one or more entries of system/network pairs available in a geographic region, each entry including a system/network pair (SID/NID) and an index to an Acquisition Table that separately defines communication channels for each entry. By contrast, the PLMN 804 may include entries of MCC/MNC pairs and a RAT for each country/network pair.

Regardless of the network operator and/or service provider, a mobile device may be configured to perform multi-mode system selection in the same way and using the same system selection software application. In order to accommodate the various ways in which a network operator may provide system/network information (entries) in provisioned databases (e.g., having different information frameworks), the mobile device may be adapted to consolidate all provisioned databases into a single (common or unified) database (e.g., having different information frameworks).

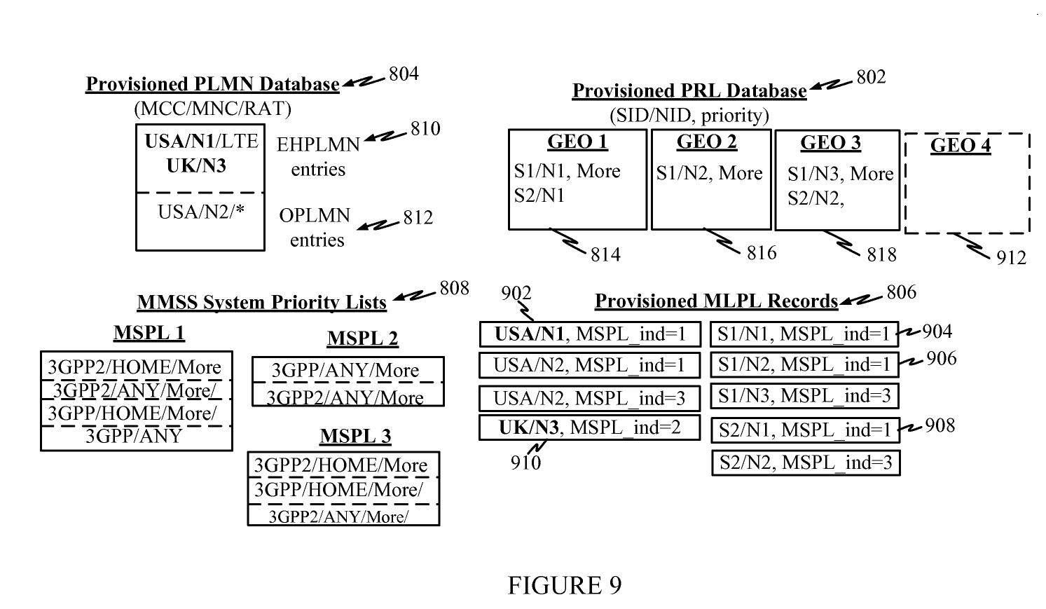

FIG. 9 illustrates how to map EHPLMN entries 810 from the PLMN database 804 into the PRL database 802, so that a geographic record (e.g., GEOs 814, 816, and 818) for each PLMN database entry may be determined. For example, for entry USA/N1 in the EHPLMN entries 810, the provisioned MLPL records 806 are used to determine that USA/N1 has a MSPL index=1. That is, a first entry 902 in MPLP record 806 identifies USA/N1 as having MSPL index=1. The MLPL records 806 may also define System/Network pairings with a corresponding MSPL index. It can be seen here that certain System/Network pairings 904, 906, and 908 also have the same MSPL index=1. Since System/Network pairings S1/N1 904 and S2/N1 908 belong to GEO_1 814 and System/Network pairing S1/N2 906 belongs to GEO_2 816, then entry USA/N1 is inserted into GEO_1 814 and GEO_2 816. Consequently, the entry USA/N1 in the PLMN database 804 is mapped to the geographic record (GEO_1 814) in which System/Network pairs having the same MSPL index are found.

Similarly, the geographic record (GEO) for PLMN database 804 entry UK/N3 is mapped to the PRL database 802. Here, a second entry 910 in the MLPL records 806 indicates that UK/N3 has an MSPL index=2. However, the MLPL records 806 do not contain a System/Network entry for MSPL index=2. Therefore, a new GEO_4 912 may be created to insert the entry UK/N3.

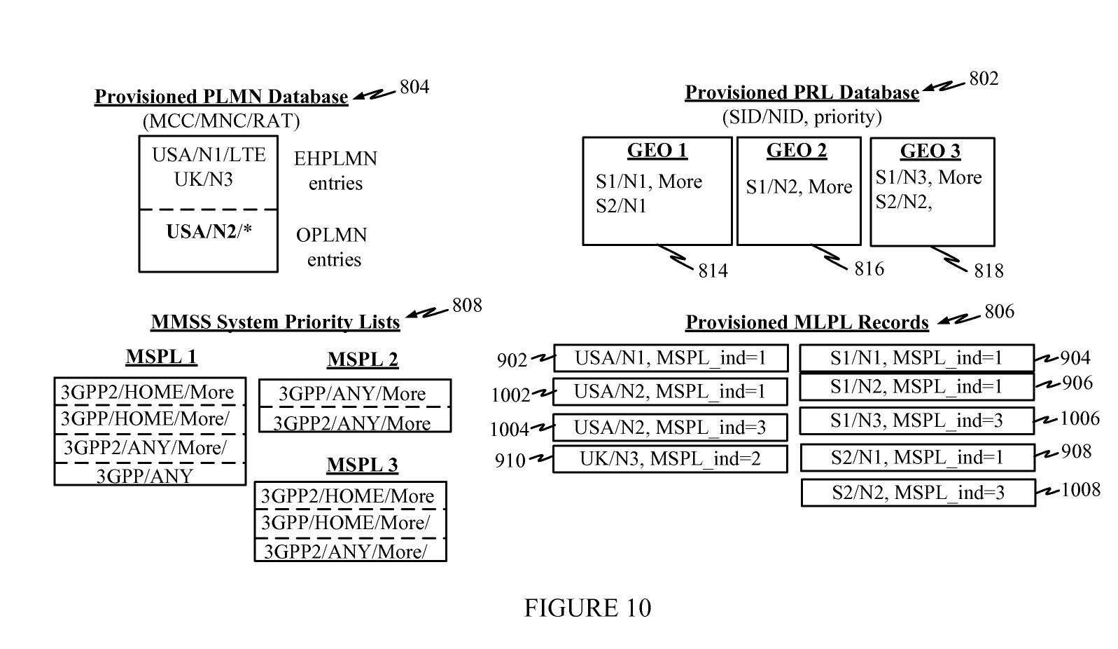

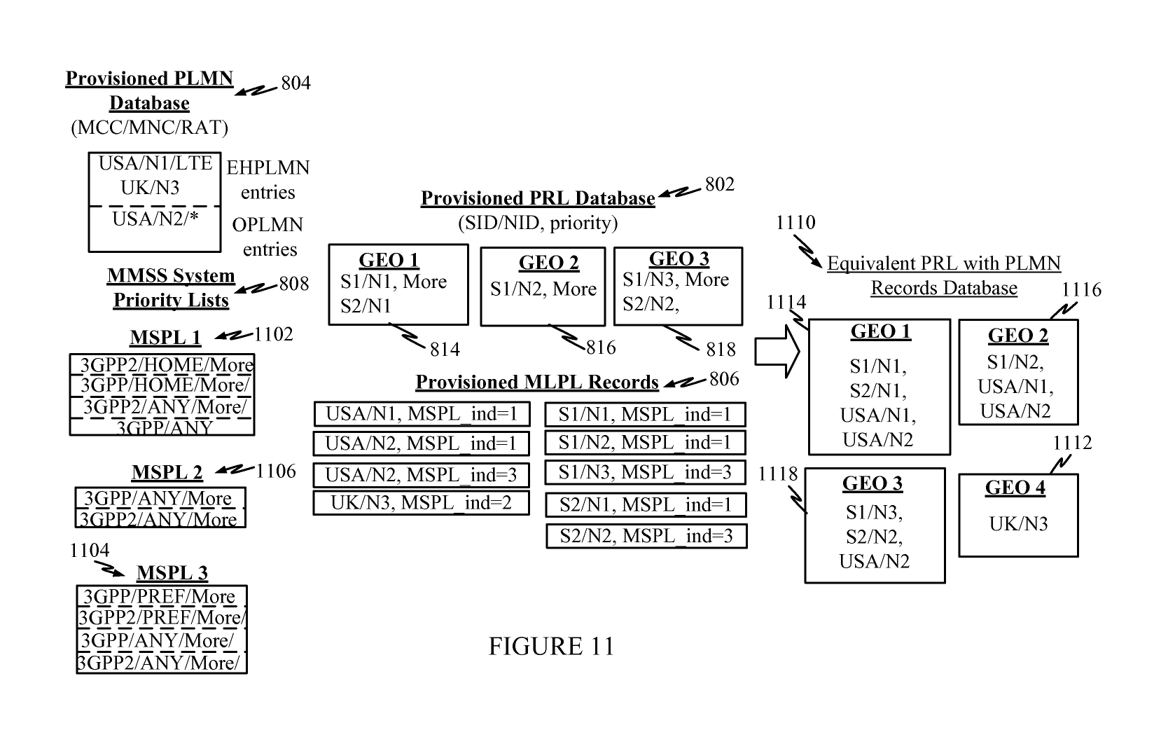

FIG. 10 illustrates how to map OPLMN entries from the PLMN database 804 into the PRL 802, so that the geographic records (GEOs) for each PLMN database entry may be determined. The geographic record (GEOs) for PLMN database 804 entry USA/N2 is mapped to the PRL database 802. Here, a third entry 1002 and fourth entry 1004 in the MLPL records 806 indicate that USA/N2 has MSPL index=1 and MSPL index=3, respectively. Therefore, the mapping procedure is implemented twice, once for MSPL index=1 and once for MSPL index=3. First, MSPL index=1 has three System/Network pairs 904, 906, and 908 within GEO_1 814 and GEO_2 816. Second, MSPL index=3 has two System/Network pairs 1006 and 1008 within GEO_3 818. Thus, entry USA/N2 will be inserted into three geographic records: GEO_1 814, GEO_2 816, and GEO_3 818.

FIG. 11 illustrates the resulting unified database 1110 with updated geographic records 1112, 1114, 1116, and 1118 after mapping the PLMN system entries into the PRL database 802 but before arranging the entries according to an order of priority or preference within each geographic record (GEO). The system entries in geographic record GEO_1 1114, which include system entries associated with MSPL index=1, may be ordered according to the priority/preference order specified in MSPL_1 1102. That is, the rules of MSPL_1 1102 state that S1/N1>USA/N1>S2/N1>USA/N2.

Similarly, GEO_2 1116, which includes system entries associated with MSPL index=1, may be ordered according to the preference order specified in MSPL_1 1102. That is, the rules of MSPL_1 1102 state that S1/N2>USA/N1>USA/N2.

Likewise, GEO_3 1118, which includes system entries associated with MSPL index=3, may be ordered according to the preference order specified in MSPL_3 1104. That is, the rules of MSPL_3 1104 state that USA/N2>S1/N3>S2/N2.

Lastly, GEO_4 1112, which includes system entries associated with MSPL index=2, may be ordered according to the preference order specified in MSPL_2 1106. Since GEO_4 912 was a new GEO, only UK/N3 is found therein.

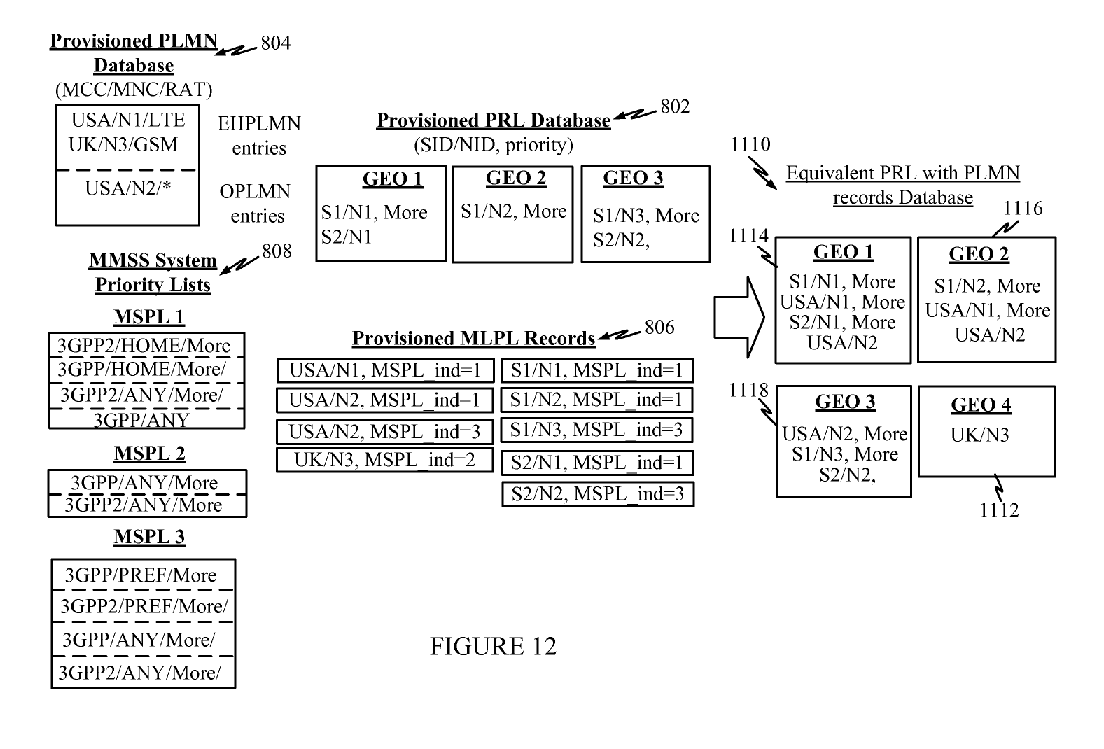

FIG. 12 illustrates the resulting unified database 1110 with updated geographic records 1112, 1114, 1116, and 1118 after the entries have been rearranged according to an order of priority within each geographic record.

FIG. 13 illustrates how the PLMN system records that have been added to the PRL database are linked to acquisition records. An Acquisition Table 1300 may include a plurality of acquisition records, each acquisition record defining one or more channels, frequency bands, and/or radio access technologies. A System Table 1301 may include a plurality of geographic records (e.g., prioritized system/network pairs per region) along with a respective acquisition index to an acquisition record in the acquisition table 1300.

According to the PLMN database 804, entry USA/N1 is an LTE RAT only system. Therefore, the geographic record GEO_1 1114 includes entry USA/N1 with an acquisition index=4. This links entry USA/N1 to a first acquisition record 1302 (i.e., acquisition index=4) that has all LTE bands. According to the PLMN database 804, entry USA/N2 is present in all RATs. Therefore, the geographic record GEO_1 1114 includes entry USA/N2 with an acquisition index=5. This links entry USA/N2 to a second acquisition record 1304 that has all LTE, UMTS and GSM bands. Lastly, according to the PLMN database 804, entry UK/N3 is a GSM RAT only system. Therefore, geographic record GEO_4 1112 includes entry UK/N3 with an acquisition index=6, linking it to a third acquisition record 1306 that has all GSM bands.

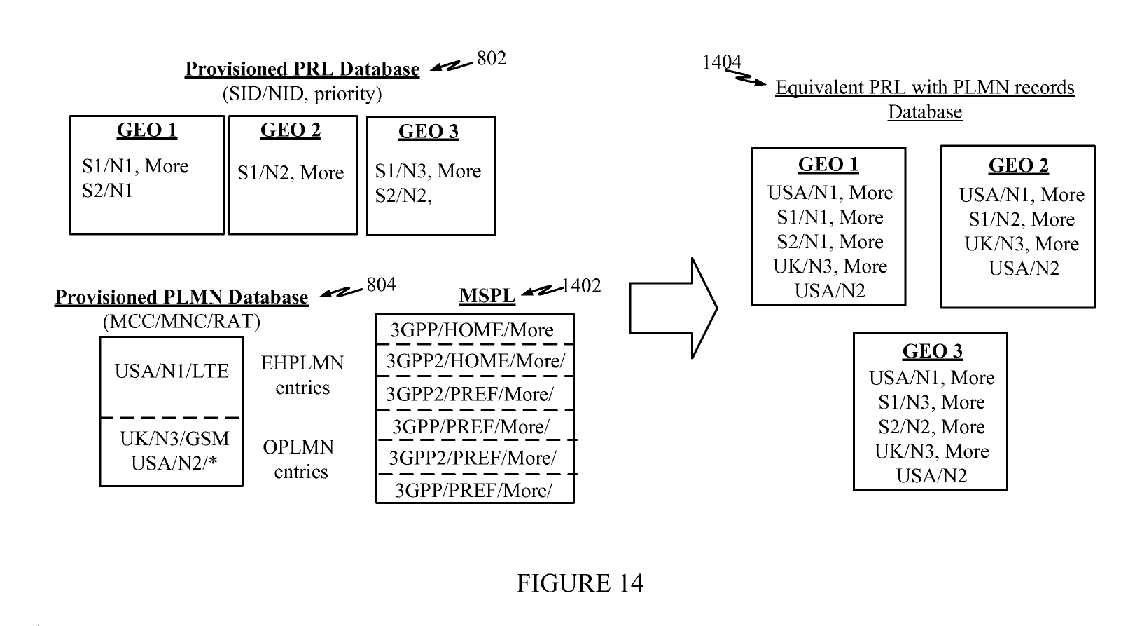

FIG. 14 illustrates another example of how various types of MMSS frameworks, provisioned within a mobile device, may be converted into a 3GPP2 MMSS PRL-based framework when a single MMSS system priority list is used. In this example, no MLPL records are configured and a single MMSS System Priority List 1402 is used. This permits a network operator to use a single priority ordering 1404 of systems in all regions. With this approach, all PLMN entries are inserted in all geographic records (GEOs).

### Handling Special Cases

There may be some instances where there are records in the PRL and PLMN database, but these records do not have corresponding MLPL records. A “non-MLPL Systems” may include, for example, some CDMA2000 and 3GPP systems which do not have a MLPL record. The following cases are possible when such non-MLPL systems exist:

(a) PLMN database has a non-MLPL 3GPP System;

(b) both PLMN database and PRL have non-MLPL 3GPP Systems;

(c) PRL has a GEO in which all the systems are non-MLPL 3GPP systems.

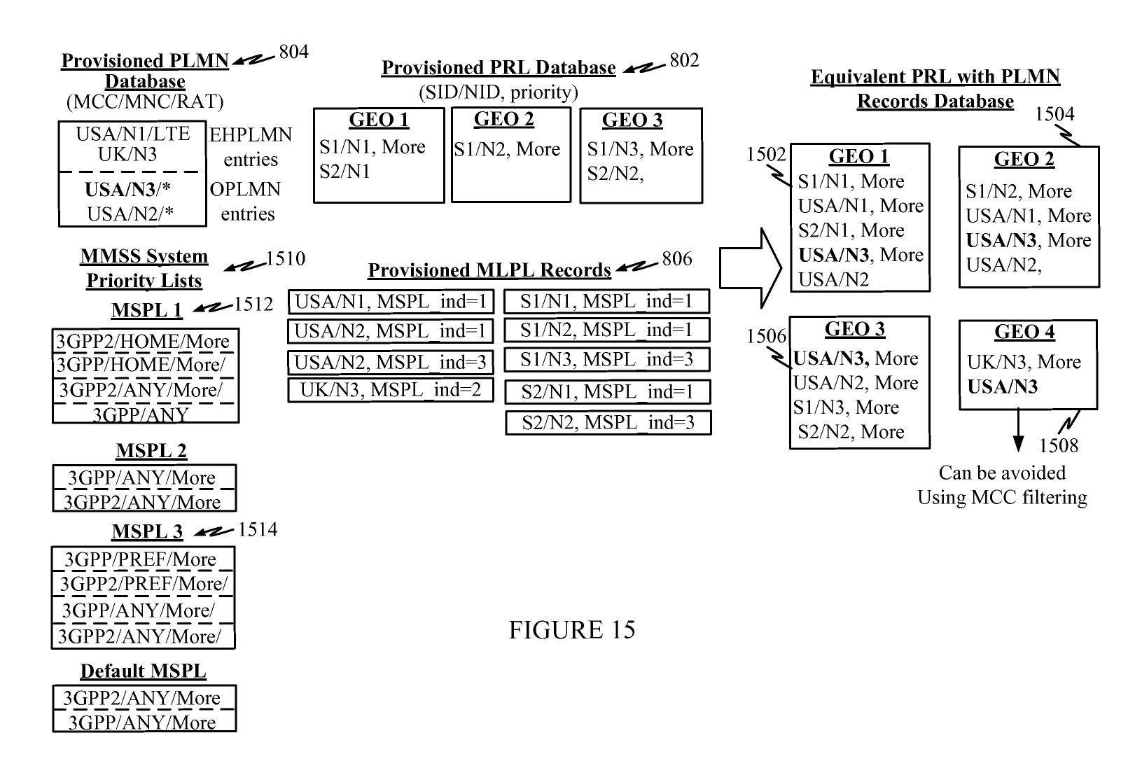

FIGS. 15, 16, and 17 illustrate how these three special MMSS database cases may be handled.

FIG. 15 illustrates a first special case where the PLMN database has a non-MLPL PLMN record. In this example, entry USA/N3 in the PLMN database 804 does not have a MLPL record in the MPLM records 806. To solve this problem, a system record corresponding to the PLMN entry USA/N3 is added to every geographic record (GEOs 1502, 1504, 1506, and 1508). The priority of the system entry USA/N3 is determined by the rules in the MSPL 1510 linked to each geographic record 1502, 1504, 1506, and 1508. For example, the entries in GEO_1 1502 are arranged according to MSPL 1 1512. The rules of MSPL 1 1512 state that entry USA/N3 is the second least preferred system in the geographic record GEO_1 1502. Similarly, the system entries in geographic record GEO_3 1506 are arranged according to the priority rules in MSPL 3 1516. The rules of MSPL 3 1514 state that entry USA/N3 is the most preferred system/network in the geographic record GEO_3 1506.

This approach may be further optimized so that PLMN System entries are not added to geographic records (GEOs 1502, 1504, 1506, and 1508) in which other PLMN entries with different Mobile Country Codes (MCC) have been explicitly added. For instance, this rule can be used to avoid adding USA/N3 to GEO_4 1508 which already has UK/N3 in a different country.

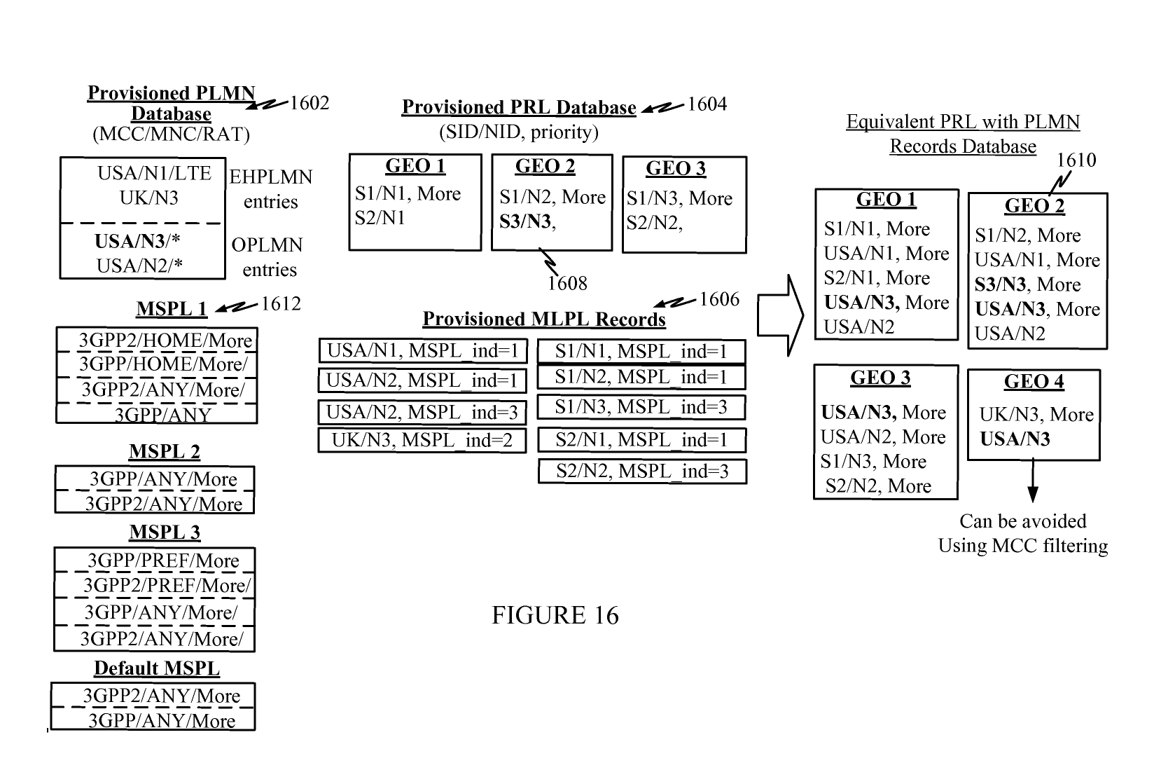

FIG. 16 illustrates a second special case where the PRL database 1604 has a non-MLPL CDMA2000 entry or record. In this example, entry S3/N3 in geographic record GEO_2 1608 of the provisioned PRL database 1604 does not have a corresponding MLPL record. That is, the provisioned MPLP records 1606 do not include an entry for S3/N3. To solve this problem, the non-MSPL CDMA2000 systems are retained only in the geographic records (GEOs) in which they were provisioned. In this example, entry S3/N3 is only maintained in the geographic record 1610. The priority of the entry S3/N3 may be determined by the MSPL (i.e., MSPL 1 1612) linked to the geographic record (GEO_2 1610). To determine the position of entry S3/N3, note that GEO_2 1610 is linked to MSPL 1 1612. The priority rules defined by MSPL 1 1612 state that entry S3/N3 (3GPP2/PREF) is of lower priority than USA/N1 (3GPP/HOME), and the priority rules defined by MSPL 1 1612 state that entry S3/N3 (3GPP2/PREF) has a higher priority than USA/N3 and USA/N2 (3GPP/PREF) in geographic record 1610.

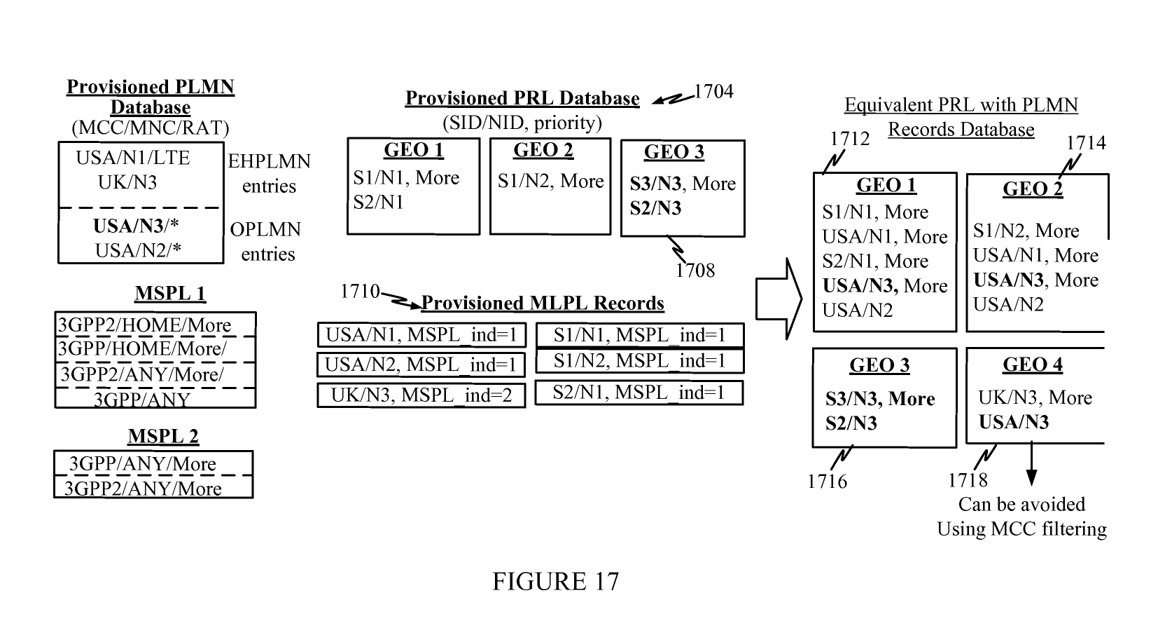

FIG. 17 illustrates a third special case where the provisioned PRL database 1704 has an entire geographic record (i.e., GEO_3 1708) with non-MLPL CDMA2000 entries or records. That is, none of the CDMA2000 systems in GEO_3 1708 of the provisioned PRL database 1704 have corresponding MLPL records in the MLPL records 1710 (i.e., there is no MLPL record corresponding to S3/N3 or S2/N3). To solve this problem, the geographic records (GEOs) in which none of the CDMA2000 systems have MLPL records may be left untouched. That is, geographic records GEO_1 1712, GEO_2 1714, and GEO_4 1718 do not include non-MLPL CDMA2000 entries S3/N3 or S2/N3. The non-MLPL CDMA2000 entries S3/N3 or S2/N3 are only kept in the geographic record GEO_3 1716. However, this may result in the mobile device trying to acquire a CDMA2000 system without an MLPL record for long periods of time. For instance, if the mobile device tries to acquire S3/N3, it will remain camped on S3/N3 until it loses coverage.

### Recommendations to Avoid Special Cases

In order to avoid the special cases noted above, a network operator may ascertain that the provisioned MSPL/MLPL, PRL database and PLMN database are synchronized (i.e., no CDMA2000, PLMN records without a corresponding MLPL record, all CDMA2000 records in a GEO should point to the same MSPL). In order to prevent databases from going out of synchronization due to Subscriber Identification Module (SIM) replacement in the mobile device, a system/network operator may use a Universal Integrated Circuit Card (UICC) to store all the databases. Suppose the PRL database and MSPL/MLPL are stored in non-volatile memory while the PLMN database is stored in the SIM. The mobile device user might change the SIM card temporarily while visiting another country. The mobile device user may want to give the local SIM priority. In order to achieve this, the mobile device user may be prompted with a manual PLMN selection option when the mapping table construction function identifies PLMN records without corresponding MLPL records in the SIM card.

### Creation of Mapping Table

A mapping table, to map the PLMN entries into a PRL database, may be constructed by the mobile device the first time it powers up. The mapping table would be updated if the MSPL, MLPL, PRL database, or PLMN database are changed or updated. According to a first approach, a change indicator is given if any of these files (e.g., MSPL, MLPL, PRL database, or PLMN database) are changed over the air using over-the-air service provision (OTASP)/Dynamic Mobile Update (DMU), for example. This may be ascertained by noticing a change in the version number of the file (e.g., the version number has incremented). The mapping table is reconstructed only if the change indicator is received.

According to a second approach, where no such change indicator is available, when a mapping table is constructed, a checksum is calculated on the MSPL, MLPL, PRL database and PLMN database contents. This checksum may be store in non-volatile memory. On every power up, the checksums for the current MSPL, MLPL, PRL database and PLMN database are recalculated and compared with the stored values. If the checksums do not match, the mapping table is reconstructed using the current MSPL, MLPL, PRL and PLMN database.

### Method Operational in Mobile Device for MMSS Using Unified Database

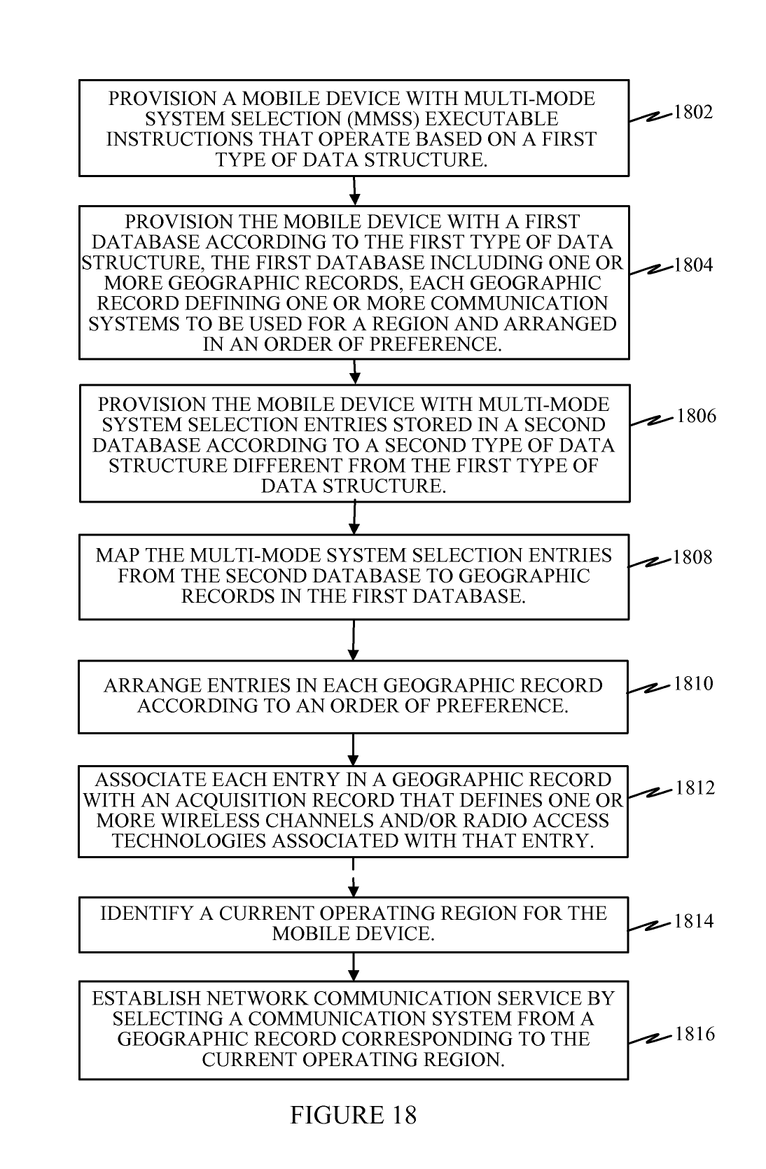

FIG. 18 illustrates a method that may be operational in a mobile device for performing multi-mode system selection using a unified database. Rather than having to provide executable instructions (e.g., code or software) for each different type of database framework, a mobile device is provisioned with multi-mode system selection (MMSS) executable instructions that operate based on a first type of data structure 1802 (e.g., PRL database according to 3GPP2). The mobile device is also provisioned with a first database according to the first type of data structure (e.g., PRL-based framework), the first database including one or more geographic records (e.g., GEOs), each geographic record defining communication systems (e.g., System/Network pairs) to be used for an operating region and arranged in an order of preference or priority 1804. The mobile device may also be provisioned with multi-mode system selection entries stored in a second database (e.g., PLMN database) according to a second type of data structure (e.g., PLMN-based framework) different from the first type of data structure 1806.

The multi-mode system selection entries may be mapped from the second database to geographic records in the first database 1808. Entries in each geographic record may then be arranged according to an order of preference or priority 1810. Each entry in a geographic record may then be associated with an acquisition record that defines one or more channels associated with that entry 1812.

Having setup all MMSS entries for a plurality of different systems within the first database, the mobile device may subsequently identify a current operating region 1814. The mobile device may then establish wireless network communication service by selecting a communication system (e.g., system and network) from a geographic record corresponding to the current operating region 1816.

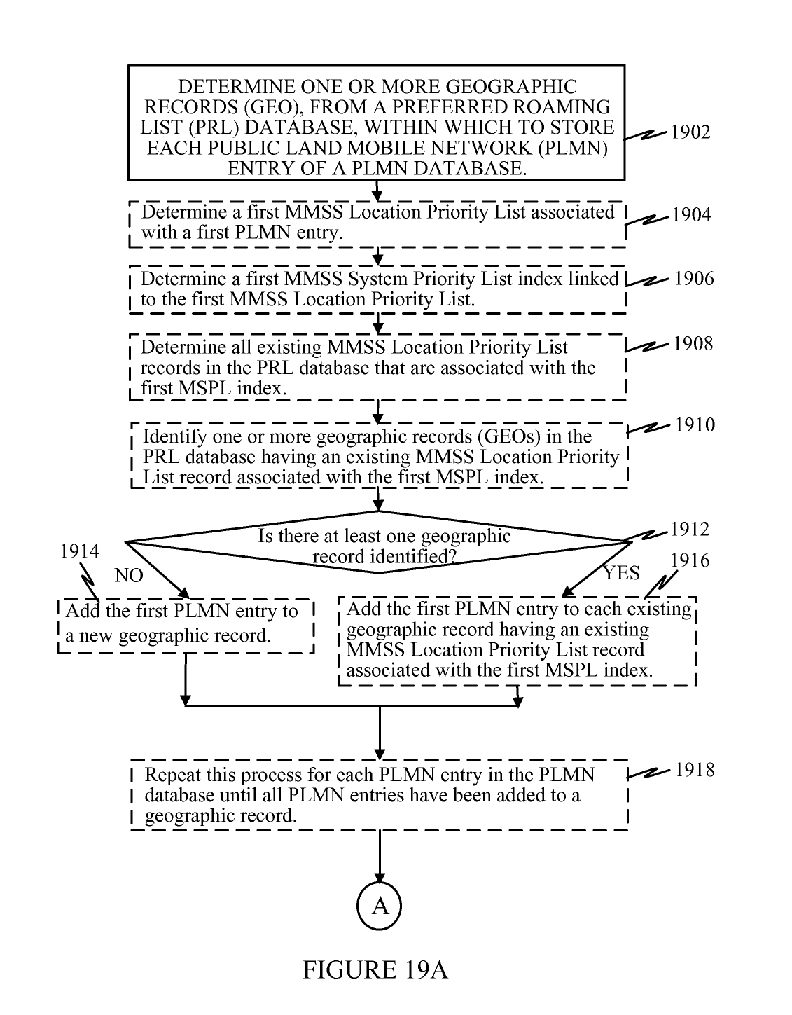

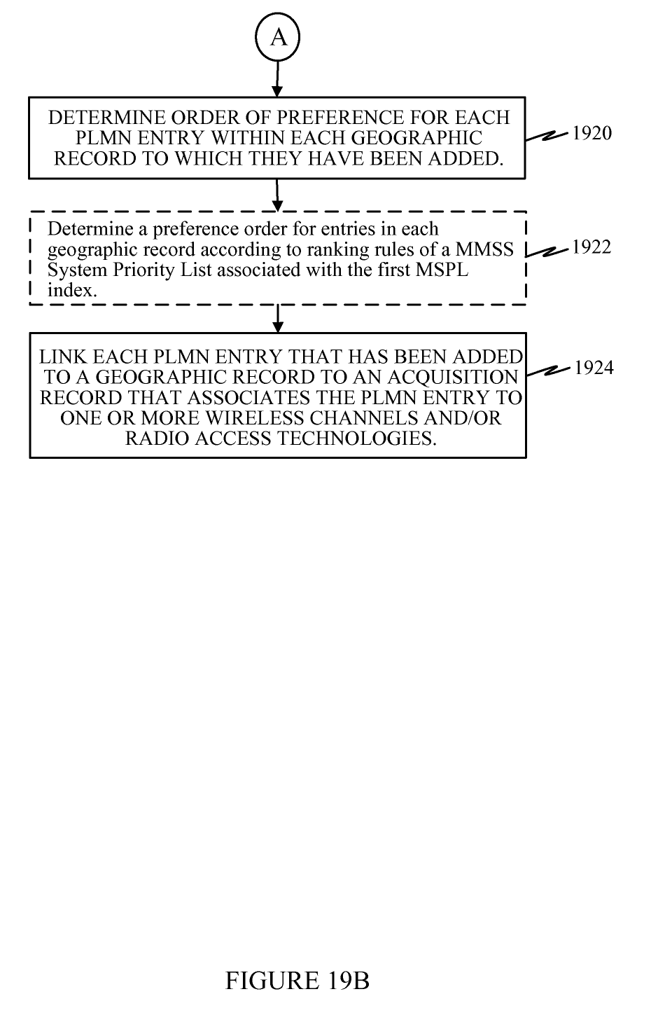

FIGS. 19A and 19B illustrate a method that may be operational in a mobile device for performing multi-mode system selection (MMSS) using a PRL database that incorporates records from a PLMN database. Upon an initial power up, the mobile device may determine one or more geographic records, from a preferred roaming list (PRL) database, within which to store each PLMN entry of a PLMN database 1902. For example, the mobile device may determine a first MMSS Location Priority List associated with a first PLMN entry 1904. Then, a first MMSS System Priority List index linked to the first MMSS Location Priority List 1906 is identified or determined. All existing MMSS Location Priority List records in the PRL database that are associated with the first MSPL index are determined or identified 1908. One or more geographic records (GEOs) in the PRL database having an existing MMSS Location Priority List record associated with the first MSPL index are identified 1910. If there is at least one geographic record identified, then the first PLMN entry is added to each existing geographic record having an existing MMSS Location Priority List record associated with the first MSPL index 1916. Otherwise, a new geographic record is created and the first PLMN entry is added to that new geographic record 1914. This process may be repeated for each PLMN entry in the PLMN database until all PLMN entries have been added to a geographic record 1918.

After adding each of the PLMN entries of the PLMN database into one or more geographic records of the PRL database, the mobile device may determine an order of preference for each PLM entry within each geographic record to which they have been added 1920. That is, a preference order is determined for entries in each geographic record according to ranking rules of a MMSS System Priority List associated with the first MSPL index 1922 (in the previous example).

Each PLM entry that has been added to a geographic record may then be linked or associated with an acquisition record that associates the PLMN entry with one or more wireless channels and/or radio access technologies (RAT) 1924.

Note that, because the 3GPP2 system selection has the highest level of granularity in specifying, grouping and prioritizing systems, it is capable of accommodating other types of systems, including 3GPP systems. Hence, this method provides a MMSS solution that uses the PRL (PRL-based MMSS) to specify the prioritization of 3GPP and 3GPP2 systems in a multi-mode mobile device that can perform system/network selection supporting multiple standards. For example, this concept would aid a multi-mode (e.g., GSM, cdma2000, DO, WCDMA, LTE) mobile device in determining and selecting a preferred air-technology. The choice of preferred system may depend on a number of factors such as the location of the mobile device and/or roaming agreements between network operators.

The framework for multi-mode system selection (MMSS) may include multiple steps. First, a plurality of MMSS databases may be provisioned in a mobile device. Each of the MMSS databases may be selected or provided by a different network/system operator and, consequently, may be based on different frameworks or structures (e.g., network, location, preference rules, etc., are arranged in different types of data structures).

Second, the plurality of MMSS databases are consolidated into a single standard database. That is, records or entries from the plurality of MMSS databases are converted to a unified MMSS database. Third, the mobile device may be provisioned with a set of rules used by to determine the most preferred network or system available in its current region of operation using the unified MMSS database. In this manner, the databases and the rules in any MMSS framework can be converted into a common standard database that is already implemented. This allows leveraging an existing database implementation but still support different network operator requirements.

Note that the mobile device may implement database consolidation upon initial power-up and/or when a change is detected in the PRL database, PLMN database, MLPL and/or MSPL. Alternatively, a system/network operator may generate its MMSS database and convert it using the process described in FIGS. 1-19. The system/network operator may then provide the converted database to a mobile device. Thus, the database merging and/or conversion may be performed either by the mobile device or by the system/network operator.

In one embodiment, the selected standard database uses a Preferred Roaming List database (PRL) used in 3GPP2 system selection, which has the highest level of granularity in specifying, grouping and prioritizing of networks or systems. The information in the other types of database frameworks (e.g., PLMN records) can be captured without any loss of information in the PRL database with PLMN records.

### Exemplary Mobile Device

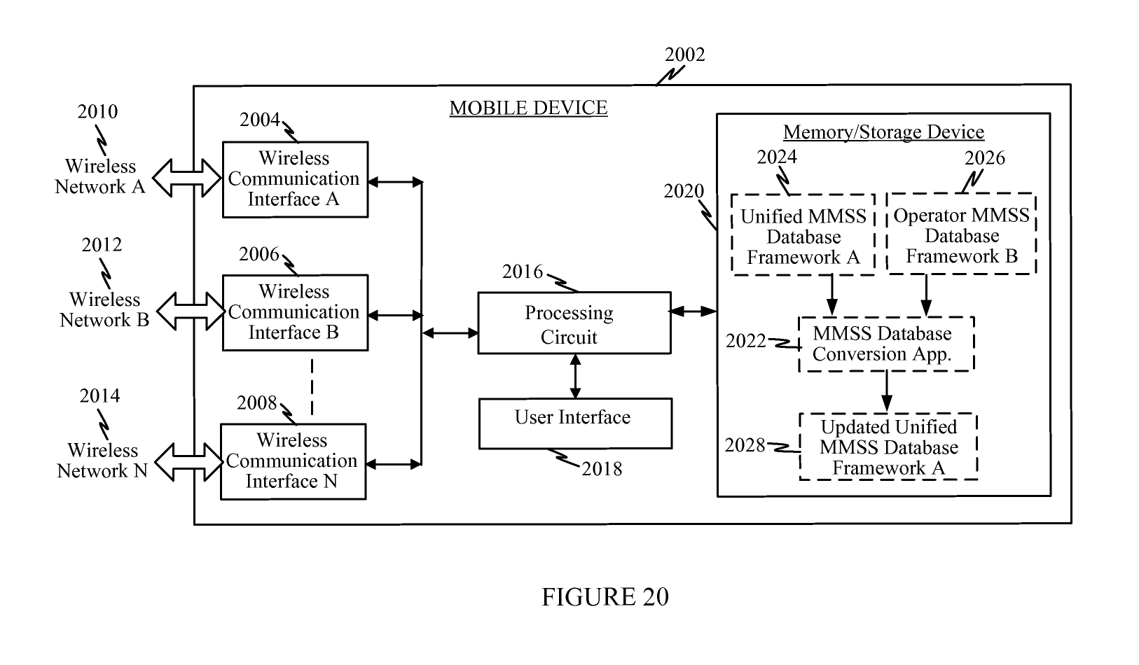

FIG. 20 is a block diagram illustrating an example of a mobile device that may be configured to perform multi-mode system selection where multiple different MMSS frameworks are converted to a single unified database. According to various implementations, the mobile device 2002 may include a wireless or mobile phone, a cell phone, a laptop computer, a handheld user device such as a wireless tablet, a mobile communication device, a wireless or mobile digital media player, among other wireless and/or mobile electronic devices capable of voice, data, and/or multimedia communications (i.e., transmission and/or reception). The mobile device 2002 may also be interchangeably referred to as a node, terminal, apparatus and/or station that is allowed to communicate over a network based on a subscription or subscription-less based service provided by one or more network or system operators.

The mobile device 2002 may include a plurality of different wireless communication interfaces 2004, 2006, and/or 2008 that are configured to communicate over different types of wireless networks 2010, 2012, and 2014 (e.g., utilizing different communication standards). Each wireless communication interface 2004, 2006, and/or 2008 may include a transmitter/receiver circuit, a transmitter/receiver chain, etc., to achieve transmissions and/or reception over a corresponding wireless network. In some cases, the wireless communication interface 2004, 2006, and/or 2008 may share certain circuit components.

The mobile device 2002 may also include a processing circuit 2016 coupled to the wireless communication interfaces 2004, 2006, and/or 2008, a memory or storage device 2020, and a user interface 218. The user interface 2018 may include input interfaces, such as an audio microphone, a keypad, a touch screen, as well as output interfaces, such as an audio speaker and a display screen. The memory or storage device 2020 may include volatile and/or non-volatile memory (e.g., a Subscriber Identification Module).

In various implementations, the processing circuit 2016 may comprise one or more processors or processing units that are adapted to perform or execute one or more operations or applications that facilitate voice, data, and/or multimedia communications to and/or from the mobile device 2002. For example, the processing circuit 2004 may be adapted to perform one or more mobile IP protocols that allows the mobile device 2002 to communicate over the one or more wireless network 2010, 2012, and/or 2014, either concurrently or one at a time.

The memory or storage device 2020 may serve to store applications and/or data used by the processing circuit 204. For example, the memory or storage device 2020 may include an MMSS database conversion application 2022 that is adapted to convert and/or transfer entries from a network operator MMSS database 2026 (having a framework B) into a unified MMSS database 2024 (having a framework A) to generate an updated unified MMSS database 2028 (having a framework A). To accomplish this transfer or conversion, the MMSS database conversion application 2022 may perform one or more of the steps, methods, and/or features illustrated in FIGS. 1-19. For example, the unified MMSS database 2024 (framework A) may be compatible with a 3GGP2 MMSS database framework (e.g., Preferred Roaming List framework) while the Operator MMSSS database 226 may be any other type of framework, including a 3GPP MMSS database framework (e.g., PLMN framework).

The various illustrative logical blocks, modules and circuits and algorithm steps described herein may be implemented or performed as electronic hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. It is noted that the configurations may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

When implemented in hardware, various examples may employ a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

When implemented in software, various examples may employ firmware, middleware or microcode. The program code or code segments to perform the necessary tasks may be stored in a machine-readable or computer-readable medium such as a storage medium or other storage(s). One or more processors may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In one or more examples herein, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Software may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

One or more of the components, steps, and/or functions illustrated in the Figures may be rearranged and/or combined into a single component, step, or function or embodied in several components, steps, or functions without the features described herein. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational in a mobile device for multi-mode system selection, comprising:
provisioning the mobile device with a first database including one or more geographic records, each geographic record for storing one or more communication system entries having a first type of data structure, the one or more communication system entries to be used for establishing communications in a region;
provisioning the mobile device with a second database including one or more multi-mode system selection entries having a second type of data structure different from the first type of data structure;
mapping the multi-mode system selection entries from the second database to one or more geographic records in the first database; and
establishing network communication service by selecting a first communication system from a geographic record corresponding to a current operating region for the mobile device.

2. The method of claim 1, further comprising:
identifying the current operating region for the mobile device.

3. The method of claim 2, further comprising:
performing multi-mode system selection using the first database by selecting a geographic record corresponding to the current operating region and selecting the first communication system entry based on the current operating region.

4. The method of claim 3, wherein the first communication system is identified as a system entry of highest priority within the selected geographic record.

5. The method of claim 1, wherein the first database is compatible with a first framework type while the second database is compatible with a second framework type, where the first and second framework types are distinct.

6. The method of claim 5, wherein the first framework type is compatible with a 3rd Generation Partnership Project 2 (3GPP2) Preferred Roaming List (PRL) framework.

7. The method of claim 5, wherein the second framework type is compatible with a 3rd Generation Partnership Project (3GPP) Public Land Mobile Network (PLMN) framework.

8. The method of claim 1, further comprising:
provisioning the mobile device with additional databases of multi-mode system selection entries, where the second database and additional databases are provided by one or more network operators.

9. The method of claim 1, further comprising:
arranging entries in each geographic record according to an order of priority.

10. The method of claim 9, wherein arranging entries in each geographic record according to an order of priority includes
determining the order of priority of entries in each geographic record according to ranking rules in a third database of system priorities.

11. The method of claim 1, further comprising:
associating each communication system entry in a geographic record with an acquisition record that defines one or more communication channels associated with that entry.

12. The method of claim 1, wherein mapping the multi-mode system selection (MMSS) entries from the second database to one or more geographic records in the first database includes:
obtaining a first MMSS entry from the second database;
determining a first MMSS Location Priority List (MLPL) associated with the first MMSS entry;
determining a first MMSS System Priority List (MSPL) index linked to the first MLPL entry;
determining all existing MMSS Location Priority List (MLPL) records in the first database that are associated with the first MSPL index; and
identifying one or more geographic records in the first database having an existing MMSS Location Priority List record associated with the first MSPL index.

13. The method of claim 12, further comprising:
adding the first MMSS entry to each geographic record in the first database having an existing MLPL record associated with the first MSPL index.

14. The method of claim 12, further comprising:
adding the first MMSS entry to a newly created geographic record in the first database if no existing geographic records in the first database have a MLPL record associated with the first MSPL index.

15. The method of claim 12, wherein the first MMSS entry is a Public Land Mobile Network (PLMN) entry.

16. The method of claim 12, further comprising:
determining an order of priority of entries in each geographic record according to ranking rules in a multi-mode system selection (MMSS) System Priority List associated with the first MSPL index; and
arranging entries in each geographic record according to the order of priority.

17. A mobile device adapted for multi-mode system selection (MMSS), comprising:
one or more wireless communication interfaces for communicating over one or more different types of networks according to different communication standards;
a memory device adapted to
store a first database including one or more geographic records, each geographic record for storing one or more communication system entries having a first type of data structure, the one or more communication system entries to be used for establishing communications in a region, and
store a second database including one or more multi-mode system selection entries having a second type of data structure different from the first type of data structure; and
a processing circuit coupled to the one or more wireless communication interfaces, the processing circuit adapted to perform MMSS database conversion by:
mapping the multi-mode system selection entries from the second database to one or more geographic records in the first database;
establishing network communication service by selecting a first communication system from a geographic record corresponding to a current operating region for the mobile device.

18. The mobile device of claim 17, wherein the processing circuit is further adapted to perform multi-mode system selection by accessing the first database and selecting from among one or more networks in a given region.

19. The mobile device of claim 17, wherein the processing circuit is further adapted to perform multi-mode system selection using the first database by selecting a geographic record corresponding to the current operating region and selecting the first communication system based on an order of priority defined within the selected geographic record.

20. The mobile device of claim 17, wherein the processing circuit is adapted to perform the mapping from the second database to the first database upon boot-up of the mobile device whenever the second database has changed from a previous boot-up of the mobile device.

21. The mobile device of claim 17, wherein the first database is compatible with a first framework type while the second database is compatible with a second framework type, where the first and second framework types are distinct.

22. The mobile device of claim 21, wherein the first framework type is compatible with a 3rd Generation Partnership Project 2 (3GPP2) Preferred Roaming List (PRL) framework.

23. The mobile device of claim 21, wherein the second framework type is compatible with a 3rd Generation Partnership Project (3GPP) Public Land Mobile Network (PLMN) framework.

24. The mobile device of claim 17, wherein arranging entries in each geographic record according to an order of priority includes
determining a order of priority of entries in each geographic record according to ranking rules in a third database of system priorities.

25. The mobile device of claim 17, wherein mapping the multi-mode system selection (MMSS) entries from the second database to one or more geographic records in the first database includes:
obtaining a first MMSS entry from the second database;
determining a first MMSS Location Priority List (MLPL) associated with the first MMSS entry;
determining a first MMSS System Priority List (MSPL) index linked to the first MLPL entry;
determining all existing MMSS Location Priority List (MLPL) records in the first database that are associated with the first MSPL index; and
identifying one or more geographic records in the first database having an existing MMSS Location Priority List record associated with the first MSPL index.

26. The mobile device of claim 25, wherein mapping the multi-mode system selection (MMSS) entries from the second database to geographic records in the first database further includes:
adding the first MMSS entry to each geographic record in the first database having an existing MLPL record associated with the first MSPL index.

27. The mobile device of claim 25, wherein mapping the multi-mode system selection (MMSS) entries from the second database to geographic records in the first database further includes:
adding the first MMSS entry to a newly created geographic record in the first database if no existing geographic records in the first database have a MLPL record associated with the first MSPL index.

28. The mobile device of claim 25, wherein the processing circuit is further adapted to
determine an order of priority of entries in each geographic record according to ranking rules in a multi-mode system selection (MMSS) System Priority List associated with the first MSPL index; and
arrange entries in each geographic record according to an order of priority includes

29. A mobile device adapted for multi-mode system selection (MMSS), comprising:
means for provisioning the mobile device with a first database including one or more geographic records, each geographic record for storing one or more communication system entries having a first type of data structure, the one or more communication system entries to be used for establishing communications in a region;
means for provisioning the mobile device with a second database including one or more multi-mode system selection entries having a second type of data structure different from the first type of data structure;
means for mapping the multi-mode system selection entries from the second database to one or more geographic records in the first database; and
means for establishing network communication service by selecting a first communication system from a geographic record corresponding to a current operating region for the mobile device.

30. The mobile device of claim 29, further comprising:
means for associating each communication system entry in a geographic record with an acquisition record that defines one or more communication channels associated with that entry.

31. The mobile device of claim 29, further comprising:
means for determining an order of priority of entries in each geographic record according to ranking rules in a third database of system priorities.

32. A machine-readable medium comprising instructions operational in a mobile device for multi-mode system selection (MMSS), which when executed by one or more processors causes the processors to:
provision the mobile device with a first database including one or more geographic records, each geographic record for storing one or more communication system entries having a first type of data structure, the one or more communication system entries to be used for establishing communications in a region;
provision the mobile device with a second database including one or more multi-mode system selection entries having a second type of data structure different from the first type of data structure;
map the multi-mode system selection entries from the second database to one or more geographic records in the first database; and
establish network communication service by selecting a first communication system from a geographic record corresponding to a current operating region for the mobile device.

33. The machine-readable medium of claim 32, further comprising instructions which when executed by the one or more processors causes the processors to
determine an order of priority of entries in each geographic record according to ranking rules in a third database of system priorities.
